(19) United States
(12) Patent Application Publication
(10) Pub. No.: US 2012/0262264 A1
(43) Pub. Date: Oct. 18, 2012

(54) LIQUID-COOLED INDUCTIVE COMPONENT

(76) Inventors: Thorsten Engelage, Hille (DE); Dirk Erasmie, Bad Pyrmont (DE)

(21) Appl. No.: 13/445,542

(22) Filed: Apr. 12, 2012

(30) Foreign Application Priority Data
Apr. 13, 2011 (DE) 102011007334.5-34

(51) Int. Cl. H01F 27/10

(52) U.S. Cl. 336/55

(57) ABSTRACT

A liquid-cooled inductive component includes a magnetic core and pressures pieces which are arranged on two opposite sides of the magnetic core and are in mechanical contact with the magnetic core either directly or via a thermally conductive material. A winding is provided which is wound around the magnetic core and the pressure pieces, so that the pressure pieces are arranged between portions of the magnetic core and the winding. The pressure pieces are configured as hollow bodies including coolant connections, portions of the winding abutting on the pressure pieces directly or via a thermally conductive material.

### CROSS-REFERENCE TO RELATED APPLICATIONS

This application claims priority from German Patent Application No. 102011007334.5-34, which was filed on Apr. 13, 2011, and is incorporated herein in its entirety by reference.

The present invention relates to a liquid-cooled inductive component, and in particular to a liquid-cooled, passive inductive component such as a reactor or a transformer.

### BACKGROUND OF THE INVENTION

Water-cooled or, more generally, liquid-cooled inductive components such as reactors and transformers have been used in industrial converter engineering for years.

There are different methods of cooling such components. An inductive component typically consists of a coil, for example of a winding made of copper or aluminum, and a magnetic core, for example made of soft magnetic silicon iron.

Known approaches to liquid-cooling of such components consist in realizing the coil from hollow conductors and/or copper tubes through which the liquid flows. This results in various disadvantages with regard to insulation measures due to electric conductivity of the fluid. In addition, it is only the winding, i.e. the coil, itself that can be cooled. Any losses arising in the iron core more or less continue to be emitted to the ambient air via its surface.

Moreover, there are approaches wherein the entire inductive component is immersed in a closed container which has fluid located therein so that the entire component is cooled. One form of such a device is disclosed in DE 37 43 222 A1, for example. As is readily apparent, such a procedure entails considerable expenditure in realizing insulation measures and tightness requirements.

With other known approaches, cooling plates are mounted to the front ends of the magnetic iron core of the inductive component. With such variants, however, it is mainly the magnetic iron core that is cooled, whereas the winding is cooled only to a small extent.

A medium- and high-frequency power transformer wherein an iron core is cooled with water is known from DE 1057219.

DE 28 54 520 reveals an electric coil wherein a pipe through which a coolant may flow is also wound with the winding, said pipe exhibiting a flattened profile, being in tight contact with the winding, and consisting of a non-magnetic, electrically insulating material.

WO 2009/143643 A1 describes a water-cooled reactor wherein a flat radiator is arranged between at least two disc coils.

### SUMMARY

According to an embodiment, a liquid-cooled inductive component may have: a magnetic core; pressures pieces which are arranged on two opposite sides of the magnetic core and are in mechanical contact with the magnetic core either directly or via a thermally conductive material; a winding wound around the magnetic core and the pressure pieces, so that the pressure pieces are arranged between portions of the magnetic core and the winding, characterized in that the pressure pieces are configured as hollow bodies having coolant connections, and in that portions of the winding abut on the pressure pieces directly or via a thermally conductive material.

Embodiments of the present invention are based on the finding that liquid-cooling for an inductive component may be achieved in a simple and effective manner in that pressure pieces intended to exert a pressure on a magnetic iron core so as to pressure-compact or hold same are configured as hollow bodies comprising coolant connections so as to enable cooling both of the winding and of the magnetic core via the pressure pieces configured as hollow bodies.

Embodiments of the invention thus enable a liquid-cooled inductive component having as simple a structure as possible which may be manufactured at as low a cost as possible. In addition, embodiments of the invention enable almost 90% or more of the entire dissipation power arising in the operation of the inductive component to be dissipated both from the electric coil and from the magnetic iron core. Thus, embodiments of the invention enable a component which, in comparison to existing techniques, is considerably smaller, more light-weight, more compact and, thus, also cheaper.

In embodiments of the invention, the pressure pieces have two coolant connections in two mutually spaced-apart end areas of same which are connected by a fluid channel. In embodiments of the invention, the fluid channel comprises a plurality of portions having different flow cross-sections distributed across the flow channel so as to enable generation of a turbulent flow within the flow channel. In embodiments, internal walls of the hollow body define a first cross-section, the hollow body having flow cross-section reduction means provided therein which reduces, at least in portions, a flow cross-section of the fluid channel as compared to the first cross-section. Thus, it is possible to achieve a clearly increased flow rate of a coolant within the fluid channel. Moreover, it is possible to be able to generate a turbulent flow of a coolant through the fluid channel.

In embodiments of the invention, those areas of the pressure pieces on which the winding abuts are curved in cross-section, for example in the shape of a ring segment and, in particular, in the shape of a semicircle. As a result, it is possible that a substantial portion of the length of the winding, for example at least 50% or at least 60% of the entire length of the winding, abuts on the pressure pieces, so that a good heat transport from the winding to the pressure pieces is possible.

In embodiments of the invention, a thermally insulating material is further provided which is provided at least on the winding so as to prevent heat from being radiated off to the environment. This enables, in an advantageous manner, that the dissipation heat radiated off to the environment is further reduced.

Within the context of the present application, a hollow body may be understood to be a body which comprises an external wall which surrounds an internal cavity, the external wall exhibiting a maximum wall thickness of 5 mm. In embodiments of the invention, a hollow body may be understood to mean a semi-pipe, a segment pipe or a structure comprising segments that are curved at least in portions (at least where the winding abuts), said structure having a maximum wall thickness of 5 mm.

In embodiments of the invention, a cooled hollow body is used as a pressure piece, which brings about considerable advantages. On the one hand, additional losses due to a possibly existing ability of magnetic reversal of the material of which the pressure piece consists, and additional eddy-current losses that would arise if the material is conductive, may be reduced or avoided. In embodiments of the invention, the pressure piece consists of a conductive metallic material, since other materials, which are based on plastics, for example, exhibit considerably poorer thermal conductivity values.

### BRIEF DESCRIPTION OF THE DRAWINGS

Embodiments of the present invention will be detailed subsequently referring to the appended drawings, in which:

FIGS. 1a and 1b show a schematic perspective representation and an exploded representation of a liquid-cooled inductive component in accordance with an embodiment of the invention;

FIGS. 2a and 2b show a schematic perspective view and a schematic cross-sectional view of a pressure piece;

FIGS. 3a and 3b show a schematic perspective view and a schematic cross-sectional view of an alternative pressure piece;

FIGS. 4a and 4b show a schematic perspective view and a schematic cross-sectional view of a further alternative example of a pressure piece;

FIGS. 5 and 6 show schematic representations of a liquid-cooled inductive component in accordance with an alternative embodiment of the invention.

### DETAILED DESCRIPTION OF THE INVENTION

Embodiments of the invention are directed to a liquid-cooled, passive, inductive (electromagnetic) component such as a reactor or a transformer, for example. Embodiments of the invention are able to emit the thermal dissipation power, which arises during operation, both from an electric coil, i.e. the winding, and from the magnetic core itself via a cooling agent. In embodiments of the invention, the winding may consist of plastic-insulated copper or aluminum. In embodiments of the invention, the iron core may consist of soft magnetic iron plates such as silicon plate, for example. In embodiments of the invention, water may be used as the cooling agent.

The high increase in energy and material cost is causing manufacturers of electronic and electromagnetic components to turn to increasingly efficient, compact and higher-performance components. Embodiments of the invention provide a liquid-cooled inductive component which meets modern technical requirements and complies with the above requirements. Inductive components, for example reactors and transformers, are configured in the medium to high performance range, up to several megawatts, typically in a three-phase design. Embodiments of the inventive liquid-cooled inductive component may thus be directed to such a three-phase design. For such an architecture, standardized magnetic cores in normalized dimensions have been available. Likewise, coil forms, insulation materials, dedendum angles and so-called pressure pieces as well as further standardized components for many standard sizes are available from various manufacturers. Embodiments of the invention enable utilization of such standardized components.

In known inductive components, so-called pressure pieces are utilized for firmly mechanically pressure-compacting a magnetic iron core consisting of layered iron plates. In general, the pressure pieces are simple flats made of aluminum or other metals or even plastics. In embodiments of the invention, precisely said pressure pieces are extended by several decisive functions.

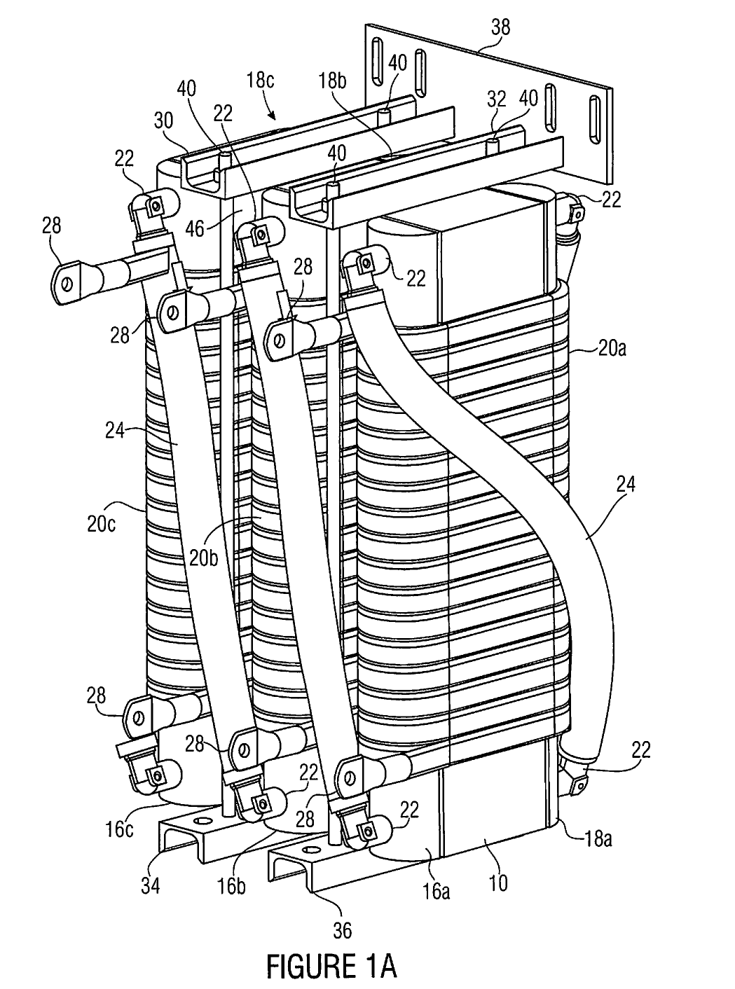

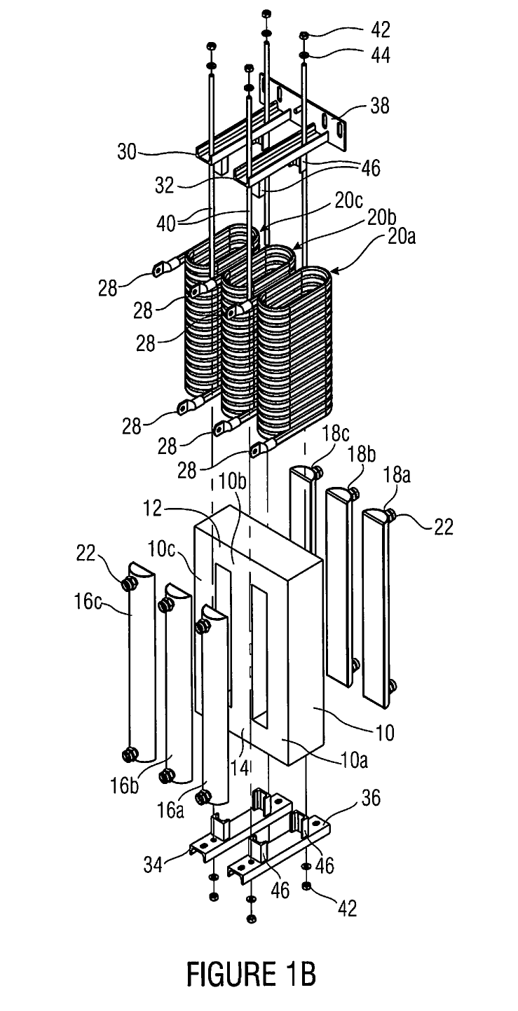

FIGS. 1a and 1b show an embodiment of the invention in a three-phase design.

The liquid-cooled inductive component shown in FIGS. 1a and 1b comprises a magnetic core 10. The magnetic core 10 includes three mutually spaced-apart legs 10a, 10b, 10c connected via yokes 12, 14 at their ends. The magnetic core may consist, in a known manner, of layered sheet iron or may consist, for example, of soft magnetic layered silicon iron.

As is shown in FIGS. 1a and 1b, pressure pieces are arranged, for each leg of the magnetic core, on two opposite sides of the magnetic core 10, namely pressure pieces 16a and 18a for the right-hand leg 10a, pressure pieces 16b and 18b for the central leg 10b, and pressure pieces 16c and 18c for the left-hand leg 10c. In the embodiment shown, the pressure pieces are in direct mechanical contact with the magnetic core. In alternative embodiments, a heat-conductive material may be arranged between the pressure pieces and the magnetic core.

The pressure pieces may be formed of any suitable, thermally conductive material such as aluminum, other metals or thermally conductive plastics.

A winding 20a is wound around the right-hand leg 10a of the magnetic core and the pressure pieces 16a and 18a, so that the pressure pieces 16a and 18a are arranged between portions of the magnetic core and the winding 20a. Similarly, a winding 10b is wound around the central leg 10b and the pressure pieces 16b and 18b, and, similarly, a winding 20c is wound around the left-hand leg 10c and the pressure pieces 16c and 18c. As is shown in FIG. 1 a, portions of the magnetic core 10 and of the pressure pieces 16a to 18c project from the windings 20a, 20b, 20c on the top and bottom sides of the windings.

The windings may consist of an insulated copper wire; an insulation material of the insulated copper wire may comprise a plastic which advantageously has a high thermal conductivity.

In embodiments, the winding may be wound in a one-ply manner.

The pressure pieces 16a to 18c are formed as hollow bodies comprising respective coolant connections 22 at mutually spaced-apart end areas. Some of the coolant connections 22 may be connected to one another via fluid lines 24 so as to implement a serial liquid cycle.

Thus, in the embodiment shown in FIGS. 1a and 1b, the lower coolant connection 22 of the pressure piece 18a is connected to the upper coolant connection 22 of the pressure piece 16a, the lower coolant connection 22 of the pressure piece 16a is connected to the upper coolant connection of the pressure piece 16b, the lower coolant connection of the pressure piece 16b is connected to the upper coolant connection of the pressure piece 16c, and the lower coolant connection of the pressure piece 16c represents an inlet or an outlet connection via which the serial liquid cycle may be connected to an external cooling cycle.

In an analogous manner, the coolant connections of the pressure pieces may be connected to one another on the rear side so as to complete the serial liquid cycle, it being possible for one of the coolant connections on the rear side to serve as an inlet/outlet connection. For example, the upper coolant connection of the pressure piece 18a may be connected to the lower coolant connection of the pressure piece 18b, the upper coolant connection of the pressure piece 18b may be connected to the lower coolant connection of the pressure piece 18c, and the upper coolant connection of the pressure piece 18c may represent an inlet/outlet connection. It is obvious to any person skilled in the art that other fluidic connections are also possible.

As may be recognized in FIG. 1a, portions of the windings 20a, 20b and 20c directly abut on the respective pressure pieces around which they are wound. In alternative embodiments, the corresponding portions of the winding may abut on the pressure pieces via a thermally conductive material.

Electric connections for the respective windings are designated by the reference numeral 28 in FIGS. 1a and 1b.

FIGS. 1a and 1b further represent a fixture including U-shaped carriers 30, 32, 34 and 36 on the top side and bottom side of the inductive component. The U-shaped carriers on the top side and/or bottom side may be attached to, e.g. soldered to, a support plate. A support plate for the upper supports 30 and 32 is designated by the reference numeral 38 in FIGS. 1a and 1b. Tensioning rods 40 are provided which may be provided with threads, so that while using corresponding nuts 42 and optional shims 44, the liquid-cooled inductive component may be tensioned between the U-shaped carriers 30, 32, 34 and 36. To improve the support for the inductive component, inwardly projecting tongues 46 may be provided at the U-shaped carriers, respectively, which tongues 46 engage with the magnetic core in the areas of the yokes 12, 14.

In the embodiment shown in FIGS. 1a and 1b, the pressure pieces 16a, 16b, 16c, 18a, 18b and 18c are configured as hollow bodies in the form of half-pipes. A respective flow of liquid through an inner cavity of the pressure pieces may be effected by the coolant connections 22, so that the pressure pieces may be utilized as cooling pressure pieces. Thus, in addition to having the task of firmly mechanically pressure-compacting and/or holding together a laminated iron core, a pressure piece also has the task of cooling both the iron core and the winding in that a coolant flows through the pressure piece, which is configured as a hollow body.

As is shown in FIG. 1a, the flat sides of the pressure pieces 16a, 16b, 16c, 18a, 18b and 18c directly abut on respective portions of the magnetic iron core 10. In the embodiment shown, the entire inductive component, which may be a reactor, is built from a total of six pressure pieces, so that a very large surface area results where the resulting dissipation heat in the magnetic iron core may leak off directly to the cooling agent. The thermal resistance via said path is many times lower than if the resulting dissipation power had to be emitted to the ambient air via the surface of the magnetic iron core. Thus, only a small part of the “iron losses” remains, which is emitted to the ambient air.

A second substantial advantage resulting from the pressure pieces being implemented as semi-pipes consists in that the winding may be placed to be very tight mechanically on the semicircle. As a result, here, too, a very low thermal resistance may arise from the winding material, i.e. the material from which the coil is wound, to the pressure pieces receiving dissipation-power energy. For example, if one looks at the mechanical structure of the entire reactor, about two thirds of the entire length of the winding, i.e. of the entire length of the coil, may directly abut on the pressure pieces. The remaining third mechanically abuts on the iron core, i.e. the respective legs. The dissipation power arising in the electric coil formed by the winding thus is split up as a function of the thermal resistances, and a large part thereof flows directly in the direction of the pressure pieces via the material of the winding, e.g. copper, namely where the winding abuts on the pressure pieces. The remainder arrives back in the pressure pieces via the relatively low thermal resistance of the iron core, i.e. through the center of the core, via the surfaces where the pressure pieces abut on the magnetic core.

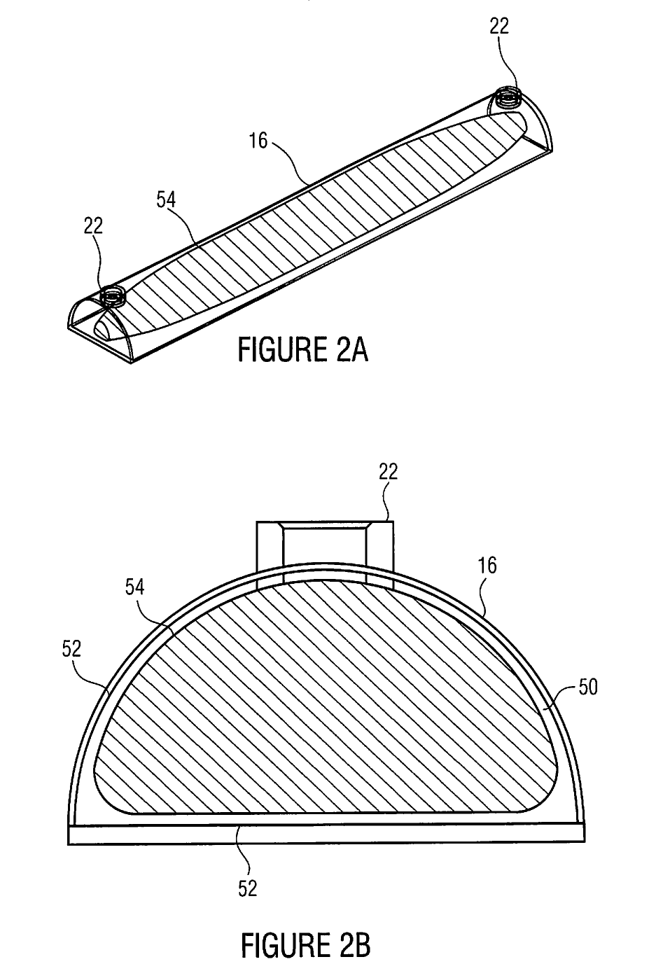

In embodiments of the invention, the flow cross-section within the pressure pieces may be reduced, by suitable measures, such that the fluid within the pressure pieces transitions from a laminar to a turbulent flow. To this end, a reduction in the cross-section may result in a higher flow rate, which also contributes to a reduction of the transition resistances. Embodiments of how a reduction in cross-sectional may be achieved are shown in FIGS. 2 to 4. In this respect it is to be noted that in FIGS. 2 to 4 the walls of the pressure pieces are depicted to be transparent so as to enable a view of their internal workings.

FIG. 2a shows an example of a pressure piece 16 having two coolant connections 22, which establish a fluidic connection to an inner cavity of the pressure piece. A first flow cross-section of the pressure piece 16 is defined by the inner walls 52 of the pressure piece. This flow cross-section is reduced, in the embodiment shown in FIGS. 2a and 2b, by a body 54 arranged within the inner cavity. In the area of the coolant connections 22, the body 54 has a first cross-section, and in a central area thereof it has a second cross-section larger than the first cross-section. In the embodiment shown, the body 54 exhibits a continuous transition between the cross-sections.

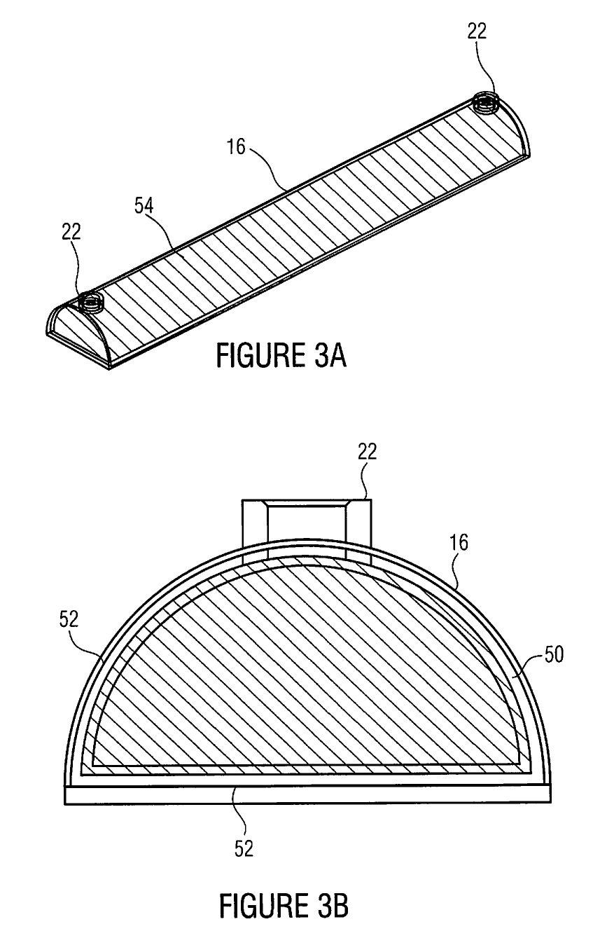

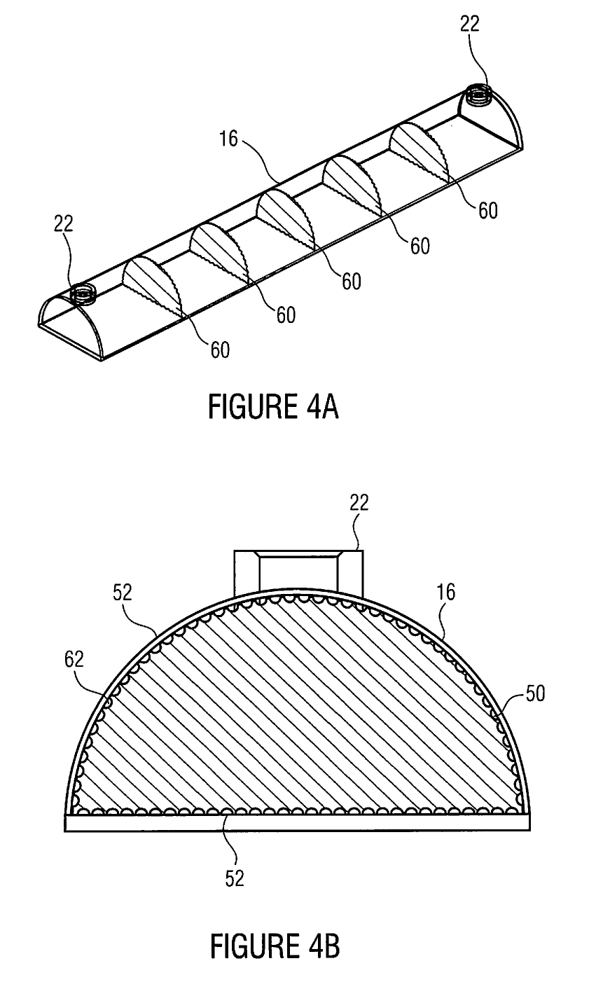

An alternative embodiment, wherein a body 56 is formed so as to implement a uniform reduced flow cross-section within the inner cavity 50 of the pressure piece 16, is shown in FIGS. 3a and 3b.

FIGS. 4a and 4b show an embodiment of a pressure piece 16 wherein a portion-by-portion tapering of the cross-section within the inner space 50 of the pressure piece 16 is implemented. As is shown in FIG. 4a, distributed positions along the pressure piece have obstacles 60 arranged thereat which result in a portion-by-portion reduction of the flow cross-section. More specifically, in this embodiment, edges of the obstacles 60, which engage with inner surfaces of the walls 52 of the pressure piece 16, comprise recesses 62 by which, together with the inner surfaces of the walls, a flow cross-section is defined.

It is obvious to persons skilled in the art that in addition to the flow cross-section reduction means shown in FIGS. 2 to 4, other means may be provided to achieve an at least portion-by-portion reduction in cross-section. For example, the inner walls of the pressure piece may be provided with corresponding protrusions so as to achieve a portion-by-portion or continuous reduction in the flow cross-section.

The procedure described, which uses pressure pieces configured as cooling pressure pieces, enables emitting any occurring dissipation powers at inductive components both from the winding and from the magnetic core into a liquid cooling agent in a targeted manner. In this context, more than 90% of the entire dissipation power of the inductive component may get into the cooling agent flowing through the pressure pieces.

In order to even further reduce the emission of the dissipation power via the air, in embodiments of the invention large surface areas of the inductive component, e.g. the winding, exposed stacks of sheets, etc., may be thermally insulated toward the outside by using a material suitable for this purpose. Suitable insulation materials may be textile materials, fiber materials and the like, for example.

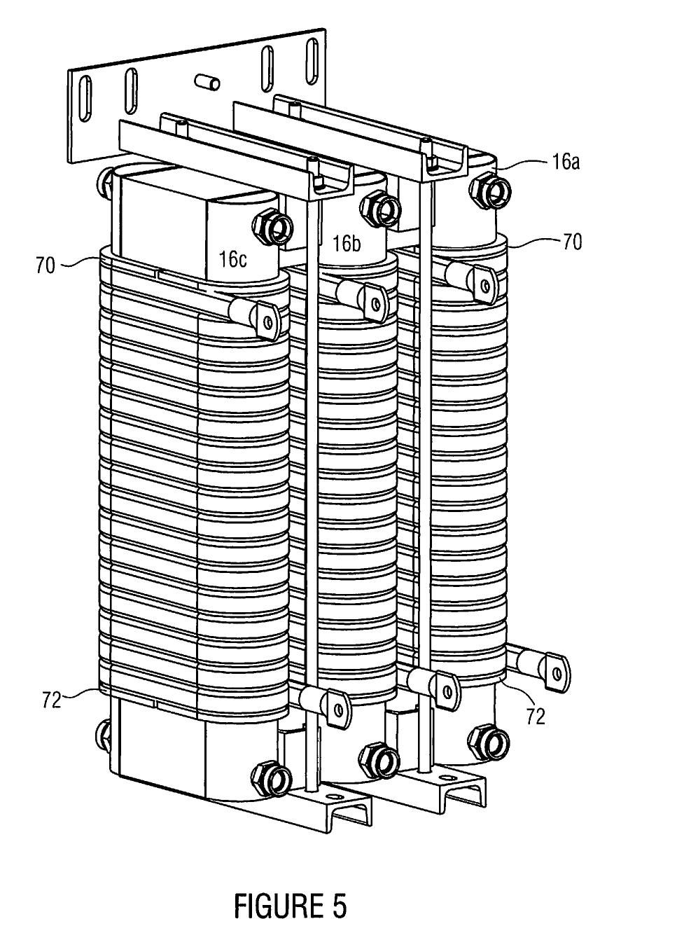

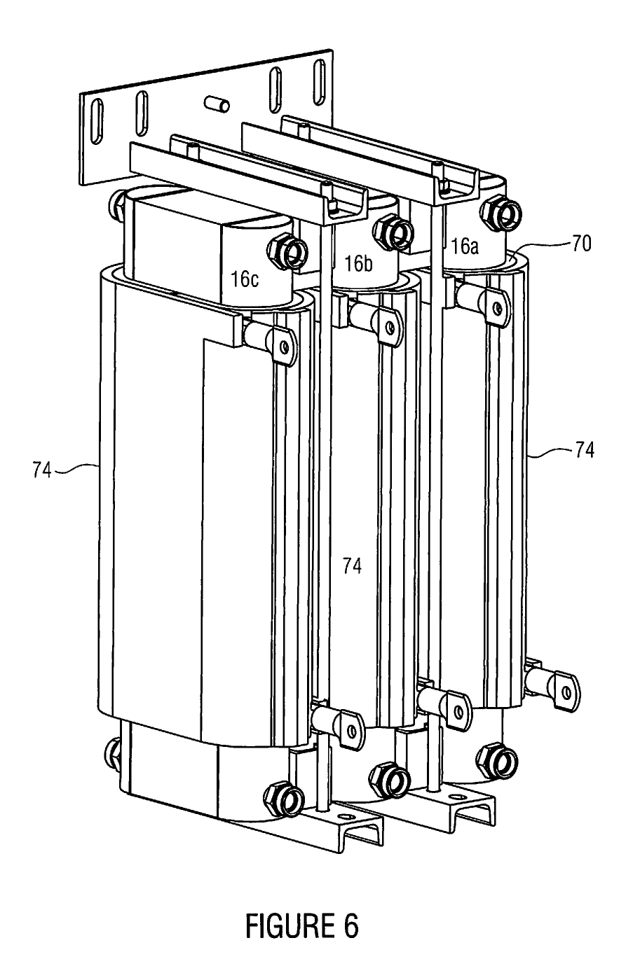

One embodiment of the invention wherein a thermal insulation material is provided on the windings is shown in FIGS. 5 and 6. The embodiment shown in FIGS. 5 and 6 corresponds to the embodiment shown above with reference to FIG. 1a, with the exception that a thermal insulation material 70, 72 is provided on the top and bottom sides of the windings, and that a thermal insulation material 74 is further provided on the side faces of the windings. In the representation in FIG. 5, the insulation material on the side faces has been omitted. By providing a corresponding thermal insulation material, the thermal connection with the fluid within the pressure pieces 16a to 16c in relation to the ambient air may further improve since the thermal resistance to ambient air is actively increased. The embodiment shown in FIGS. 5 and 6 thus enables an even more effective emission of dissipation heat.

Embodiments of the present invention thus provide a liquid-cooled inductive component which is suitable for converter applications, in particular. In embodiments of the invention, pressure pieces made of semi-pipes or comparable/similar forms are configured to be able to emit the dissipation power of the inductivity both from the magnetic iron core and from the current-carrying conductor material into the cooling liquid. In alternative embodiments, the shape of the areas of the pressure pieces on which the winding abuts may be generally curved, have the shape of a ring segment, be polygonal or semi-oval.

In embodiments of the invention, suitable measures for reducing the effective cross-section in which the cooling agent/fluid is flowing may be provided so as to produce a considerable increase in the flow rate of the cooling liquid and, thus, also a turbulent flow, as a result of which considerable further reduction of the thermal resistance from the magnetic iron core and also from the electric winding may be achieved. Corresponding flow cross-section reduction means may be configured to reduce the flow cross-section, at least in portions, by more than 50%, more than 80%, or more than 90% as compared to the flow cross-section defined by the inner walls.

In embodiments of the invention, a suitable thermally insulating material may be wound around portions of the inductive component or around the entire inductive component so as to further reduce the dissipation power emitted via the surface of the inductance. As was explained above with reference to FIGS. 5 and 6, the windings may be provided with a thermally insulating material, for example. Alternatively, those portions of the magnetic core 10 and of the pressure pieces 16a, 16b, 16c, 16d, 16e and 16f which project on both sides of the windings may also be provided with a thermally insulating material. Provision of such thermally insulating materials may contribute to an immense increase in the thermal resistance from the surface of the inductance to the ambient air, which results in that the remaining portion of the originally emitted dissipation power will also flow off in the direction of the pressure pieces, so that almost 100% of the dissipation power of the inductive component may be transferred into the cooling agent.

One embodiment of the invention was described above by means of a three-phase inductive component. It is obvious to a person skilled in the art that an inductive component may also consist of a different number of phases, i.e. respective portions of a magnetic core which are provided with pressure pieces and a winding. Embodiments of the invention may exhibit one-phase, two-phase or four-phase designs, for example.

In embodiments of the invention, the magnetic core comprises layered iron sheets which may be screwed together. In alternative embodiments, layered iron plates may be held together merely by the pressure pieces and the windings as well as additional fixture elements (see tongues 46 in FIGS. 1a and 1b). In alternative embodiments, the magnetic core may be a compact magnetic core.

In embodiments of the invention, the coolant connections are arranged in mutually spaced-apart end areas of the pressure pieces. In alternative embodiments of the invention, the coolant connections may be arranged at different positions. In embodiments of the invention, the fluid channel fluidically connecting the coolant connections enables a flow of coolant essentially along the entire length of the pressure piece. For example, two coolant connections may be provided in the area of one end of the pressure piece, and a subdivided fluid channel; in the one half, there is a flow of coolant from that end of the pressure piece at which the coolant connections are provided to the opposite end, and in the other half, a corresponding backflow takes place.

In embodiments of the invention, the coolant connections of a plurality of pressure pieces are connected via one or several fluid lines outside the pressure pieces so as to implement a serial or parallel cooling cycle.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A liquid-cooled inductive component comprising:
a magnetic core;
pressures pieces which are arranged on two opposite sides of the magnetic core and are in mechanical contact with the magnetic core either directly or via a thermally conductive material;
a winding wound around the magnetic core and the pressure pieces, so that the pressure pieces are arranged between portions of the magnetic core and the winding,
wherein the pressure pieces are configured as hollow bodies comprising coolant connections, and wherein portions of the winding abut on the pressure pieces directly or via a thermally conductive material.

2. The liquid-cooled inductive component as claimed in claim 1, wherein pressure pieces each comprise two coolant connections and a fluid channel which fluidically connects the coolant connections.

3. The liquid-cooled inductive component as claimed in claim 2, wherein the fluid channel comprises a plurality of portions comprising different flow cross-sections distributed across the fluid channel.

4. The liquid-cooled inductive component as claimed in claim 2, wherein inner walls of the hollow body define a first cross-section, the hollow body having a flow cross-section reducer provided therein which reduces a flow cross-section of the fluid channel at least in portions as compared to the first cross-section.

5. The liquid-cooled inductive component as claimed in claim 4, wherein the a flow cross-section reducer reduces the flow cross-section at least in portions by more than 50%, more than 80% or more than 90%.

6. The liquid-cooled inductive component as claimed in claim 4, wherein the a flow cross-section reducer reduces the flow cross-section of the fluid channel in portions to various extents so as to be able to generate a turbulent flow of a coolant through the fluid channel.

7. The liquid-cooled inductive component as claimed in claim 1, wherein an area of the pressure pieces on which the winding abuts is curved in its cross-section.

8. The liquid-cooled inductive component as claimed in claim 7, wherein an area of the pressure pieces on which the winding abuts exhibits a ring segment shape and, in particular, a semicircular shape in its cross-section.

9. The liquid-cooled inductive component as claimed in claim 1, wherein the pressure pieces are configured as semi-pipes.

10. The liquid-cooled inductive component as claimed in claim 1, further comprising a thermally insulating material provided at least on the winding so as to reduce radiation of heat to the environment.

11. The liquid-cooled inductive component as claimed in claim 1, wherein the magnetic core comprises a plurality of legs connected via yokes at both ends of the legs, two pressure pieces being provided for each leg of the magnetic core, a separate winding being wound around each leg and the associated pressure pieces.

12. The liquid-cooled inductive component as claimed in claim 1, wherein the magnetic core and the pressure pieces comprise such a cross-sectional shape that at least 50% or at least 60% of the entire length of the winding abuts on the pressure pieces.

13. The liquid-cooled inductive component as claimed in claim 1, wherein coolant connections of a plurality of pressure pieces are connected via one or several fluid lines outside the pressure pieces so as to implement a serial or parallel cooling cycle.
